(19) United States
(12) Patent Application Publication
(10) Pub. No.: US 2012/0087840 A1
(43) Pub. Date: Apr. 12, 2012

(54) Apparatus for the Purification of Exhaust Gases containing NOx

(76) Inventor: Sebastian Hirschberg, Winterthur (CH)

(21) Appl. No.: 13/377,287

(22) PCT Filed: Jun. 11, 2010
(86) PCT No.: PCT/EP10/58265

§ 371 Date: Dec. 9, 2011

(30) Foreign Application Priority Data
Jul. 1, 2009 (EP) 09164280.1

(51) Int. Cl. B01D 53/34

(52) U.S. Cl. 422/177

(57) ABSTRACT

An apparatus (1) for the purification of an exhaust gas stream (2) containing NOx, includes a passage (3) through which a reactant (4) containing NH3 can flow, wherein the passage (3) has a jacket element (5), which surrounds the passage (3), and an inlet opening (6) for the supply of the reactant (4) containing NH₃ and an outlet opening (7). The exhaust gas stream (2) containing NOx can flow around the jacket element (5) wherein a distributor element (8) for the distribution of the reactant (4) containing NH₃ can be connected to the jacket element (5) so that the reactant (4) containing NH₃ can be introduced into the exhaust gas stream (2) by means of the distributor element (8) and can be mixed with the exhaust gas stream (2). The distributor element (8) has an opening (9) through which the reactant (4) containing NH₃ can be introduced into the exhaust gas stream (2) as a gaseous phase, wherein the reactant (4) containing NH₃ can be vaporized within the jacket element (5). The jacket element (5) includes a heat transferring element (10) so that the jacket element (5) can be heated by means of the exhaust gas stream (2).

The invention relates to an apparatus for the purification of an exhaust gas stream containing NOx.

A DeNox system is a system for the denitrification of exhaust gases, that is for the removal of nitrous gases, that is gases with the molecular formula NOx. x can in this respect in particular adopt the values 1 or 2, that is can mean NO, NO₂; values not whole numbers are also possible for x, e.g. in a combination as N₂O₃. In DeNox systems with SCR (selective catalytic reaction) catalytic converters such as are used or planned in power plants using fossil fuels, but also in diesel engines, combustion plants or cement works, ammonia (NH₃) has to be metered into the exhaust gas upstream of the catalytic converter, In the catalytic converter, a so-called reduction catalytic converter, NOx and NH₃ are converted to nitrogen (N₂) and water (H₂O).

Currently the two following principles are mainly used to provide the ammonia.

In accordance with a first already known functional principle, the vaporization of the ammonia takes place outside the exhaust gas passage. This requires a separate vaporization system or a system for the provision of gaseous ammonia and has technical safety disadvantages since it requires the storage of large quantities of liquid ammonia at a very low temperature and/or at a high pressure, which represents a considerable risk potential. This solution is being increasingly questioned for this reason today. Alternatively, ammonia can also be stored as a water-ammonia mixture or water-urea mixture, which is of considerably less concern from a technical safety aspect. In this solution, however, the required apparatus installation and the required energy for the vaporization of the water-ammonia mixture or for the vaporization of the water-urea mixture respectively and for the subsequent hydrolysis of the urea into ammonia is very large. This makes this solution economically less interesting.

Alternatively the reactant can be distributed by a throttle or restriction arranged in the interior of an atomizer tube into the exhaust gas passage, which is shown in DE 19946901. The throttle or atomizer shall serve to avoid an uneven wall film, which forms on the inner side of the atomizer tube. This solution is insofar considered to be disadvantageous, as a heat transfer to the reactant is not foreseen. The reactant thus does not vaporize in the atomizer tube but the vaporization occurs, as described below, by the direct contact of the droplets of the reactant with the hot exhaust gas.

The document U.S. Pat. No. 6,449,947 describes a solution according to which the reactant leaving a feed line is vaporized in the exhaust gas flow. The reactant is injected into the exhaust gas flow, is vaporized and is mixed extensively with the exhaust gas by a turbulence sieve. Therefrom follows that the vaporization of the reactant is effectuated by contact with the exhaust gas after having left the outlet of the feed line. Thus, liquid reactant enters the exhaust gas flow, thereby clearly indicating that the reactant can not be vaporized in the feed line. Furthermore, also the document US2006/0191254 describes a solution to mix liquid ammonia with an exhaust gas flow, whereby the liquid ammonia can be additionally mixed with a compressed gas.

A method is described for exhaust gas purification in power plants in patent U.S. Pat. No. 7,090,810 B2 in which part of the exhaust gas is separated. The separated exhaust gas stream has an aqueous urea solution added in a separate chamber, is vaporized and is converted into ammonia and CO₂ by hydrolysis. This side stream of the exhaust gas is then mixed with the main stream again by a blower and a static mixer. The risk potential can be considerably reduced by the storage of the ammonia in the form of the substantially less problematic urea and the conversion into ammonia only briefly before use; however, the pressure loss increases, which in particular stands in the way of a use of this solution for exhaust gas streams having a large volume because the energy requirements for the overcoming of the pressure loss becomes a factor of substantial influence which has the consequence of a cost disadvantage for this solution.

In the document WO2006/122581, a heating element is foreseen to vaporize a reactive liquid coming from an injection nozzle. In this case, oxidation reactions are the source of the reactive behaviour of the reactive liquid. Additionally the chamber of a regeneration device is heated by the exhaust gases passing by. In principle, this solution concerns a partial flow analogously to U.S. Pat. No. 7,090,810 B2. If the reactive liquid was heated uniquely by the exhaust gas flow, a very large partial flow would be required to provide the energy needed for the vaporization of the reactive liquid, Additionally a blower would be required which would increase the space required for the plant and the pressure drop of this solution. Moreover, it can not be excluded, that droplets may enter the main flow of the exhaust gas.

In accordance with a further already known functional principle, the atomization and then the vaporization of a water-ammonia mixture takes place directly in the exhaust gas passage. This solution is less problematic with respect to safety since such a mixture can be stored relatively problem-free; but it does require an investment in very expensive atomization nozzles. An example for such a solution is set forth in EP 1956206 A. The atomization nozzle can be formed as a single-fluid nozzle or as a two-fluid nozzle. The term single-fluid nozzle is specifically used for atomization nozzles in which only the liquid to be atomized is conveyed through the nozzle. With two-fluid nozzles, a propellant is also conveyed into the nozzle in addition to the liquid to be atomized, whereby the atomization can be improved, i.e. in particular the production of very fine droplets with a narrow droplet size distribution range and small dependence on the liquid throughput is made possible. However, a compression apparatus for the compression of the propellant is required. This compression apparatus has a high energy requirement, which results in uneconomically implementable solutions, in particular for large exhaust gas streams such as occur in industrial plants and power plants.

In addition, problems can arise with exhaust gases charged with dust if the dust is wet by droplets which have not yet vaporized and is deposited as a contaminant on walls of a film vaporizer or of a catalytic converter or at a static mixer arranged upstream of the catalytic converter in the exhaust gas stream. At a gas pressure of, for example, 6-8 bar, such two-fluid nozzles typically produce droplet size distributions with a Sauter diameter of 20-50 μm, but individual large droplets of up to 120 μm. Due to the contamination described above by the dust deposited on the walls, provision must be made that no droplets can enter into the catalytic converter or onto the mixer. The droplet flight time upstream of the catalytic converter or of a mixing apparatus must be sufficient so that a complete vaporization of these droplets is ensured and causes a corresponding large construction length of the exhaust gas passages. In small passages such as exhaust gas pipes of motor vehicles, the flight time of the droplets up to the catalytic converter only amounts to a few milliseconds, which is not sufficient to vaporize larger droplets during the flight phase. For this reason, at least the larger droplets must be separated from the exhaust gas and vaporize in a liquid film. A film vaporizer is provided for this purpose in EP 1956206 A. This is often permitted in motor vehicles since primarily a particulate filter removes the dust from the exhaust gas and the risk of contamination is thus no longer given.

A combined vaporizer and distributor, which is made up of porous fins, is described in the patent application WO 2004/079171 A1. Aqueous urea solution should be distributed and vaporized in the interior of the porous structure. The vaporization energy is removed from the flow of hot exhaust gas via thermal conductivity by the fins in accordance with his invention. The gaseous ammonia can thus escape through openings in the fins. A large number of such fins is necessary to remove the required heat for the vaporization from the flow. The correct distribution of the liquid aqueous urea solution onto this plurality of fins is technically difficult to realize due to the complex 2-phase flow in the interior of the fins. It is difficult to ensure that no liquid can emerge from the openings.

Very different volume flows of vaporized solution or only partly vaporized vapor-liquid mixtures can also emerge from the openings located at different positions in these fins depending on the position of the opening. The required uniform pre-distribution of the ammonia over the cross-section of the passageway in which the vaporizer is arranged cannot be guaranteed.

It is therefore the object of the invention to provide an apparatus for the reliable and complete vaporization of ammonia as well as for its uniform distribution over the cross-section of the passage which has a reduced energy requirement, a short construction length or small space requirements and a low pressure drop in the exhaust gas passage. At the same time, the solutions should be at least as unproblematic from a technical safety aspect as the use of a two-fluid nozzle.

It is a further object of the invention to avoid solid particles such as dust coming into contact with the reactant containing NH₃.

An apparatus in accordance with the invention for the purification of an exhaust gas stream containing NOx includes a closed passage which can be flowed through by a reactant containing NH₃, with the passage having a jacket element which surrounds the passage and an inlet opening for the supply of liquid reactant containing NH₃ and an outlet opening. The jacket element can be flowed around by the exhaust gas stream containing NOx, with a distributor element for the distribution of the reactant containing NH₃ being able to be connected to the jacket element so that the reactant containing NH₃ can be introduced into the exhaust gas stream by means of the distributor element and can be mixed with the exhaust gas stream. The distributor element has one or more openings through which the reactant containing NH₃ can be introduced into the exhaust gas stream as the gas phase. The reactant containing NH₃ can be vaporized within the jacket element For this purpose, the jacket element includes a heat-transferring element so that the jacket element can be heated by means of the exhaust gas stream.

The heat transferring element can in particular be formed as a fin or as a pipe. If the heat transferring element is formed as a pipe, it can simultaneously take over the function of the jacket element.

If the heat transferring element is formed as a pipe which simultaneously forms the jacket element, a very compact apparatus can be obtained.

A mixer can be arranged downstream of the distributor element, in particular a static mixer, to mix the exhaust gas stream with the reactant containing NH₃. The conversion of NOx with NH₃ to N₂ and H₂O takes place in a catalytic converter arranged downstream of the mixer. The catalytic converter preferably extends over the total cross-section surface of an exhaust gas passage conducting the exhaust gas stream so that the above-described conversion can take place along a path distance of the catalytic converter which is as short as possible so that the length of the catalytic converter can be as small as possible viewed in the flow direction of the exhaust gas stream.

In accordance with a variant, the jacket element can include a reactor element for the conversion of urea into NH₃; the urea can in particular be supplied to the reactor element in the liquid phase.

The reactant containing NH₃ in accordance with one of the preceding variants remains in the interior space of the jacket element and can only occur in the liquid state in the interior space. It is thus ensured that no liquid enters into the exhaust gas stream and is deposited on the inner surface of the exhaust gas passage or of the heat transferring elements located in the exhaust gas passage. For this reason, dust particles are not deposited on the inner surface of the exhaust passage, on the jacket element or on the heat transferring elements. A contamination of the inner surface of the exhaust gas passage, of the jacket element, of the heat transferring elements as well as also of any installed elements disposed downstream, such as of the distributor element or of a static mixer, can thus be avoided. The reactant containing NH₃ emerges from the distributor element via at least one opening. Since the reactant containing NH₃ is present in a gaseous phase in the distributor element, a mixing of the reactant containing NH₃ with the exhaust gas stream takes place downstream of the distributor element without the formation of a liquid phase. Any dust particles carried along in the exhaust gas stream can thus not adhere to a surface wetted with a liquid because no liquid can enter into the exhaust gas stream.

The jacket element can contain flow-deflecting installations; the jacket element can in particular contain a metal foam or ceramic foam. The heat which was removed from the exhaust gas stream is distributed by means of heat conductivity in the total foam. The flow-deflecting installations serve for the redistribution or deflection of the flow of the reactant containing NH₃. The redistribution or deflection results in the formation of breakaways and/or eddies, which has the consequence of an increase in the heat transfer, whereby an efficient heating of the reacting containing NH₃ becomes possible. The combination of heat transfer and heat conductivity is surprisingly much higher for a metal foam or ceramic foam than for flow-deflecting installations such as are common for static mixers.

The metal foam or ceramic foam in particular has open pores so that the total volume which is taken in by the metal foam or ceramic foam is available for the heat transfer and for the deflection or redistribution.

The jacket element and also the metal foam or ceramic foam advantageously have a thermal conductivity of at least 15 W/m K, preferably at least 30 W/m K, particularly preferably at least 60 W/m K, so that the heat transfer from the exhaust gas stream to the reactant containing NH₃ is additionally improved.

The jacket element and/or the metal foam can have a catalytically effective surface, in particular when a variant is provided in which a decomposition of urea is provided for the production of a reactant containing NH₃.

The metal foam can contain aluminum; it can in particular be formed as an aluminum alloy. A metal foam of aluminum can be produced simply and can thus be procured comparatively inexpensively.

The ceramic foam can, for example, be designed as a silicon carbide ceramic material. Silicon carbide has a very high thermal conductivity, high wear resistance and good strength and can be processed to open-pore foam structures.

The reactant containing NH₃ can include an aqueous ammonia solution. The aqueous ammonia solution is introduced into the jacket element in the region of the inlet opening. The water vaporizes due to the heat transfer so that both the arising NH₃ and the remaining water are present in the gaseous phase.

The exhaust gas stream can amount to at least 12 m³/h, preferably at least 1000 m³/h, particularly preferably at least 10,000 m³/h. The inlet temperature of the exhaust gas stream into the passage amounts to at least 150° C.

The passage in which the exhaust gas stream flows can have a cross-section area which amounts to at least 0.0007 m², preferably at least 0.05 m², particularly preferably at least 1 m².

The apparatus in accordance with one of the preceding embodiments can be used for the purification of an exhaust gas stream containing NOx from an industrial plant, in particular a power plant. Denitrification plants for exhaust gases from power plants, for exhaust gases from diesel engines or exhaust gases from waste incineration plants can be named as further possible uses.

The invention will be explained in the following with reference to the drawings. There are shown:

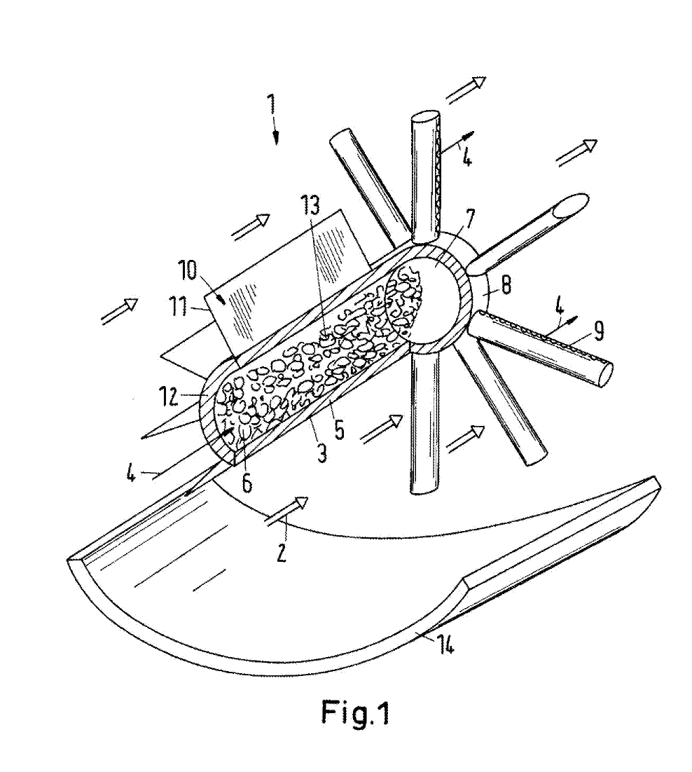

FIG. 1 a schematic view of the apparatus in accordance with the invention;

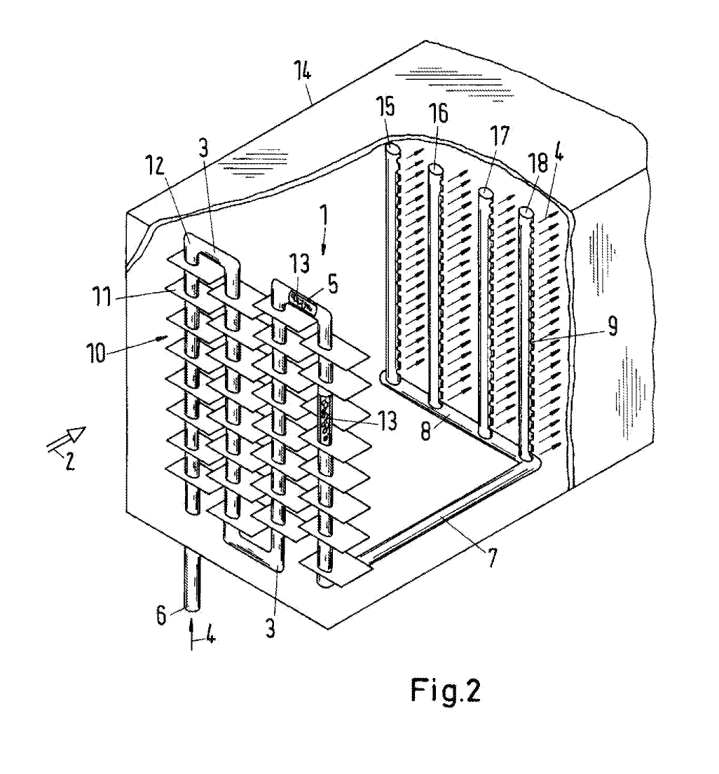

FIG. 2 a schematic view of a second embodiment variant of the apparatus in accordance with the invention.

An apparatus 1 in accordance with the invention for the purification of an exhaust gas stream 2 containing NOx in accordance with FIG. 1 includes a closed passage 3 through which a reactant 4 containing NH₃ can flow. The passage is partly cut away in FIG. 1 to make the installations visible. The passage has a jacket element 5 which surrounds the passage 3 and includes an inlet opening 6 for the supply of reactant containing NH₃ and an outlet opening 7. The outlet opening 7 opens into a distributor element 8. The exhaust gas stream 2 containing NOx can flow around the jacket element 5. A distributor element 8 for the distribution of the reactant 4 containing NH₃ can be connected to the jacket element 5 so that the reactant 41 containing NH₃ can be introduced into the exhaust gas stream 2 by means of the distributor element and can be mixed with the exhaust gas stream 2. The distributor element 8 has a hollow inner space as well as one or more openings 9 through which the reactant 4 containing NH₃ can be introduced into the exhaust stream 2 as the gas phase. The reactant 4 containing NH₃ can be vaporized within the jacket element, that is the reactant 4 containing NH₃ vaporizes in the inner space of the jacket element 5. For this purpose, the jacket element 5 includes a heat-transferring element 10 so that the jacket element 5 can be heated by means of the exhaust gas stream 2.

FIG. 2 shows a schematic view of a second embodiment variant of the apparatus in accordance with the invention. The individual elements of the same function are given the same reference numerals as in FIG. 1. FIG. 2 shows an exhaust gas passage 14 which contains an apparatus 1 for the purification of an exhaust gas stream 2 containing NOx. A reactant 4 containing NH₃ can flow through a closed passage 3. This passage 3 is shown as a pipe extending in serpentine-like manner, The extent of the closed passage 3 naturally does not have to be serpentine-like, it could also, for example, extend spirally, which is not shown here. The extent of the pipe in the exhaust gas passage 14 is such that the total cross-section surface of the exhaust gas passage 14 can be used for the heat exchange.

The passage 14 is partly cut away in FIG. 2 to make the installations visible. The passage 3 is furthermore shown cut at two points to show its installations. A heat transferring element can be attached in the inner space of the passage 3, which is formed as a hollow space surrounded by a jacket element 5, said heat transferring element being formed, for example, as a metal foam or as a ceramic foam. The heat transferring element can, however, also include fillers or a combination of different installations. The installations can also be provided only at some sections of the passage.

The passage has an inlet opening 6 for the supply of reactant containing NH₃ and an outlet opening 7. The outlet opening 7 opens into a distributor element 8. In the present illustration, the jacket element formed as a pipe merges directly into a pipe which leads to the distributor element 8. The distributor element 8 serves for the distribution of the reactant 4 containing NH₃ so that the reactant 4 containing NH₃ can be introduced into the exhaust gas stream 2 by means of the distributor element and can be mixed with the exhaust gas stream 2. The distributor element 8 branches into at least two part elements 15, 16, 17, 18 which have a hollow inner space and one or more openings 9 through which the reactant 4 containing NH₃ can be introduced into the exhaust gas stream 2 as the gas phase.

The reactant 4 containing NH₃ can be vaporized within the jacket element, that is the reactant 4 containing NH₃ vaporizes in the inner space of the jacket element 5. For this purpose, the jacket element 5 includes a heat-transferring element 10 so that the jacket element 5 can be heated by means of the exhaust gas stream 3. The heat transferring element 10 in accordance with FIG. 1 or FIG. 2 can in particular be formed as a fin 11 or as a pipe 12. As a rule, a plurality of fins 11 is provided which are formed as plate-shaped elements. The plates preferably extend in the flow direction of the exhaust gas stream 2 so that the exhaust gas stream 2 sweeps past the plate-shaped elements. The plate-shaped elements are naturally only a preferred embodiment for a heat transferring element. Alternatively or in addition, tubular elements, thickened portions, disk-shaped elements, rod-like elements, vane-like elements, grid structures, metal foams and the like can be provided. These elements can naturally be arranged in any desired combination with one another.

The exhaust gas stream has a higher temperature than the heat transferring element 10 so that a heat transfer takes place from the heat transferring element 10 to the reactant 4 containing NH₃. If the heat transferring element 10 is formed as a pipe 12, it simultaneously takes over the function of the jacket element 5. The heat transfer in this case takes place from the exhaust gas stream via the pipe wall to the reactant 4 containing NH₃. This heat transition may be sufficient if the required temperature difference between the exhaust gas stream 2 and the reactant 4 containing NH₃ is large enough or the volume flow 2 of reactant 4 containing NH₃ is so small that the available heat transfer area is sufficient in every case.

In addition, the jacket element 5 in accordance with FIG. 1 or FIG. 2 is preferably produced from material with good heat conductivity so that. the heat transfer can be improved. The jacket element 5 has a thermal conductivity of at least 15 W/m K, preferably at least 30 W/m K, particularly preferably at least 60 W/m K.

If the temperature difference between the exhaust gas stream 2 and the reactant 4 containing NH₃ is small and/or if a larger portion of reactant containing NH₃ is necessary because the concentration of NOx in the exhaust gas stream is high, the heat transition area provided by the jacket element 5 alone may not be sufficient so that the heat transferring elements can adopt at least one of the above-named embodiments.

A mixer can be arranged downstream of the distributor element 8 in accordance with each of the embodiments shown, in particular a static mixer, to mix the exhaust gas stream with the reactant containing NH₃. This mixer is not shown graphically.

In accordance with a method variant, the reactant 4 containing NH₃ can be obtained by conversion of urea. This reaction could also take place in the interior of the jacket element 5. The jacket element can include for this purpose a reactor element, not shown, for the conversion of urea into NH₃; the urea can in particular be supplied to the reactor element in the liquid phase. The supply of the urea can take place, for example, by means of an apparatus such as is shown in EP 1956206 A.

The jacket element in accordance with FIG. 1 or 2 can contain flow-deflecting installations having good heat conductivity which can be formed as metal foam or as ceramic foam 13. The metal foam or ceramic foam 13 preferably has open pores; the reactant 4 containing NH₃ can flow through the metal foam uniformly. The metal foam or ceramic foam 13 can in particular be in heat conducting communication with the jacket element so that the heat of the exhaust gas stream can be transferred via heat conductivity by the jacket element 5 and by the metal foam or ceramic foam 13 onto the reactant 4 containing NH₃.

The exhaust gas stream 2 has a higher temperature than the heat transferring element 10 so that a heat transfer takes place from the heat transferring element 10 to the reactant 4 containing NH₃, In accordance with FIG. 2, the heat transferring element 10 is formed as a pipe 12 with fins 11 arranged thereon and it simultaneously takes over the function of the jacket element 5. The heat transfer in this case takes place from the exhaust gas stream via the fins and the pipe wall to the reactant 4 containing NH₃. This heat transition can be sufficient if the required temperature difference between the exhaust gas stream 2 and the reactant 4 containing NH₃ is large enough or the volume flow 2 of reactant 4 containing NH₃ is so small that the available heat transfer area is sufficient in every case.

In a small exhaust gas passage with 1 m² cross-section area, an exhaust gas temperature of 200° C. at a velocity of the exhaust gas stream of 8.2 m/s, a vaporizer system in accordance with the invention was tested and was compared with a vaporizer pipe which was equipped with installations in accordance with the prior art (EP 0 655 275 B1). The mass flow ratio of the water-ammonia mixture to be added relative to the exhaust gas was 0.3%. The water-ammonia mixture had an ammonia portion of 20%. In this case, a vaporizer in accordance with the invention could be used with an inner diameter of 30 mm and a length of the vaporizer of 6 in. In contrast thereto, the already known vaporizer had an inner diameter of 20 mm and a length of 66 m. The pressure loss in the reactant containing NH₃ is much smaller in the vaporizer in accordance with the invention than in the already known vaporizer. In the last part of the vaporizer, where the reactant has already been largely vaporized, pressure losses of around 1 bar/m are achieved in the vaporizer in accordance with the invention, whereas 3 bar/m arise in the vaporizer in accordance with the prior art. The vaporizer in accordance with the invention produces a pressure loss in the exhaust gas stream of 0.22 mbar, whereas the already known vaporizer effects a pressure loss in the exhaust gas at 2.4 mbar which is higher by more than one order of magnitude. A comparable pressure loss as in the static mixer optionally arranged downstream of the apparatus is thus produced with the apparatus in accordance with one of the embodiments in accordance with the invention.

The length of the passage 3 is much smaller than for a solution in accordance with the prior art. In addition, the pressure loss in the exhaust gas passage 14 produced by the passage 3 due to the smaller length of the apparatus in accordance with the invention is surprisingly much lower than in the already known solution.

1-15. (canceled)

16. A structured packing comprising
a first layer having a plurality of first corrugations forming a plurality of open channels therebetween, each said channel including a first corrugation valley having a valley bottom, a first corrugation peak having a first apex and a second corrugation peak, having a second apex, wherein said first corrugation peak and said second corrugation peak bound said first corrugation valley;
an indentation formed on said first apex of said first corrugation peak and extending in the direction of said first apex, at least one point of said indentation being spaced from said valley bottom of said corrugation valley a distance smaller than the spacing of said first apex from said first valley bottom of said first corrugation valley; and
a second layer having a plurality of second corrugations forming a plurality of open channels therebetween, said second layer being disposed in contact with said first layer with said open channels of said first layer crossing said open channels of said second layer characterized in that said contact is interrupted in said indentation.

17. A structured packing as set forth in claim 16 further comprising a second indentation arranged on said second apex of said second corrugation peak of said first layer.

18. A structured packing as set forth in claim 17 further comprising a third indentation arranged on said valley bottom of said first corrugation valley of said first layer.

19. A structured packing as set forth in claim 16 wherein said first layer has a first marginal boundary and a second marginal boundary parallel to said first marginal boundary.

20. A structured packing as set forth in claim 19 further comprising a second indentation arranged on said second apex of said second corrugation peak of said first layer and a third indentation arranged on said valley bottom of said first corrugation valley of said first layer, each of said first indentation, said second indentation and said third indentation being arranged between said first marginal boundary and said second marginal boundary.

21. A structured packing as set forth in claim 20 wherein at least one of said first indentation, said second indentation and said third indentation is made as a lenticular dent.

22. A structured packing as set forth in claim 16 wherein the spacing of said first apex from said first valley bottom of said first corrugation valley is constant.

23. A structured packing as set forth in claim 16 wherein at least a part of said first apex is made as an edge.

24. A structured packing as set forth in claim 16 wherein at least a part of said first corrugation valley is made in V shape.

25. A structured packing as set forth in claim 16 wherein each said channel of said second layer includes a first corrugation valley having a valley bottom, a first corrugation peak having a first apex and a second corrugation peak having a second apex, wherein said first corrugation peak and said second corrugation peak bound said first corrugation valley; and an indentation formed on said first apex of said first corrugation peak and extending in the direction of said first apex, at least one point of said indentation being spaced from said valley bottom of said corrugation valley a distance smaller than the spacing of said first apex from said first valley bottom of said first corrugation valley.

26. A structured packing as set forth in claim 16 wherein said indentation extends over a length which amounts to at most 75% of the length of said first apex of said first corrugation peak.

27. A structured packing as set forth in claim 16 wherein said indentation comprises an intermediate peak.

28. A structured packing comprising
a first layer having a plurality of first corrugations forming a plurality of open channels therebetween, each said channel including a first corrugation valley having a valley bottom, a first corrugation peak having a first apex and a second corrugation peak having a second apex, wherein said first corrugation peak and said second corrugation peak bound said first corrugation valley;
a plurality of indentations formed on said first apex of said first corrugation peak and extending in the direction of said first apex, at least one point of each said indentation being spaced from said valley bottom of said corrugation valley a distance smaller than the spacing of said first apex from said first valley bottom of said first corrugation valley;
a second layer having a plurality of second corrugations forming a plurality of open channels therebetween, each said channel including a first corrugation valley having a valley bottom, a first corrugation peak having a first apex and a second corrugation peak having a second apex, wherein said first corrugation peak and said second corrugation peak bound said first corrugation valley;
a plurality of indentations formed on said first apex of said first corrugation peak of said second layer and extending in the direction of said first apex thereof, at least one point of each said indentation being spaced from said valley bottom of said corrugation valley a distance smaller than the spacing of said first apex from said first valley bottom of said first corrugation valley; and
said second layer being disposed in contact with said first layer with said open channels of said first layer crossing said open channels of said second layer with said indentations of said first layer being arranged at least partially overlapping with said indentations of said second layer.
